(19) United States
(12) Patent Application Publication
(10) Pub. No.: US 2016/0277917 A1
(43) Pub. Date: Sep. 22, 2016

(54) METHOD AND APPARATUS FOR AUTOMATIC DETECTION AND SELECTION OF AN ALTERNATIVE ROAMING PROVIDER

(71) Applicant: NOKIA TECHNOLOGY OY, Espoo (FI)

(72) Inventors: Hannu Ilmari PIRILÄ, Littoinen (FI); Rune Adolf LINDHOLM, Sottunga (FI); Hannu BERGIUS, Kangasala (FI); Jorma KAIKKONEN, Oulu (FI)

(73) Assignee: Nokia Technologies Oy, Espoo (FI)

(21) Appl. No.: 15/034,741

(22) PCT Filed: Nov. 8, 2013
(86) PCT No.: PCT/IB2013/060016

§ 371 Date: May 5, 2016

(51) Int. Cl. H04W 8/02; H04W 48/18

(52) U.S. Cl. CPC H04W 8/02; H04W 48/18

(57) ABSTRACT

A method, apparatus and computer program product are provided to cause a plurality of network identifiers to be stored in a memory; assign a priority value to each of a plurality of networks; in an instance in which a mobile terminal is roaming, identify available networks; and select an available network based on the priority value of stored network identifiers. The selection of the available networks may further include determining the signal strength of the available networks; and further basing the selection of an available network on the signal strength of the available networks.

### TECHNOLOGICAL FIELD

An example embodiment of the present invention relates generally to selection of a network to support communications with a mobile device and, more particularly, to automatic detection and selection of an alternative roaming provider.

### BACKGROUND

Traditionally, mobile devices offered limited manual input in the selection of a network while roaming. Instead, mobile device are commonly configured to automatically connect to preferred network which as designated by a list on a SIM (subscriber identification module) card by priority order. As the mobile device roams, the handset will repeatedly monitor the available networks, and maintain the connection of the mobile device to the highest priority network in the preferred network list. In an instance in which manual selection of a network is permitted, the mobile device will detect if there is more than one network available and offer the user of the mobile device a choice. Once a network is selected, the mobile device will remain connected to the selected network regardless of the signal strength or alternative networks available.

Regulations for mobile roaming networks require that users of mobile devices be able to freely choose the mobile roaming provider. A user may select a mobile roaming provider by contract or by manual selection of the provider in the roaming area. The traditional automatic selection of the strongest network may not always be in compliance with these regulations. However, the manual selection of a network may not be within the technical capability of the user of the mobile device. In this regard, a user may have difficulty knowing when to select a network, which network to select in instances in which there are multiple options and how to make a selection.

### BRIEF SUMMARY

A method, apparatus and computer program product are provided in accordance with an example embodiment in order to facilitate the automatic detection and selection of an alternative roaming provider. As such, network availability may be monitored by a mobile device. The mobile device may automatically select an alternative roaming provider based on an assigned priority value and, in some embodiments, signal strength, thereby permitting the user of the mobile device to avoid having to make a manual selection of a network in order to choose an alternative roaming provider.

In an example embodiment, a method is provided that includes causing a plurality of network identifiers to be stored in a memory; assigning a priority value to each of a plurality of networks; in an instance in which a mobile terminal is roaming, identifying available networks; and selecting an available network based on the priority value of stored network identifiers. The method of an example embodiment may also include determining a signal strength of the plurality of available networks. The selecting a network is further based on the signal strength of the plurality of available networks. In a method of an example embodiment assigning a priority value to each of a plurality of networks includes assigning network identifiers to at least one priority list. The priority lists are based on mobile country code and at least one priority list is assigned a priority value. The method further includes determining a dominate mobile country code; and selecting of a network includes selecting the network from the at least one priority list having the dominate mobile country code. In an example embodiment of the method the network identifiers include a mobile country code and a mobile network code.

In some instances of the method, at least one the plurality of networks is a home network; in this regard the assigning of a priority value to each network includes assigning a first priority to the home network. In an example embodiment of this method, at least one of the plurality of networks is a preferred network; and in that regard the assigning of priority value to each network includes assigning a second priority to the preferred network. Further, in an example embodiment of this method, at least one of the plurality of networks includes an un-preferred network; and in this regard the assigning of a priority value to each network includes assigning a third priority value to the un-preferred network.

In another example embodiment, an apparatus is provided that includes at least one processor and at least one memory including computer program code with the memory and computer program code configured to, with the processor, cause the apparatus to cause a plurality of network identifiers to be stored in a memory; assign a priority value to each of a plurality of networks; in an instance in which a mobile terminal is roaming, identify available networks; and select an available network based on the priority value of stored network identifiers.

The at least one memory and computer program code may be further configured to, with the processor, cause the apparatus of an example embodiment to determine a signal strength of the plurality of available networks; and wherein the selecting a network is further based on the signal strength of the plurality of available networks. In an example embodiment of the apparatus, assigning a priority value to a plurality of networks includes, assigning network identifiers to at least one priority list, where the priority lists are based on mobile country code, and the at least one priority list is assigned a priority value. The at least one memory and computer program code are further configured to, with the processor, cause the apparatus to determine a dominate mobile country code and selecting of a network further includes selecting the network from the at least one priority list having the dominate mobile country code. In another example embodiment of the apparatus the network identifiers include a mobile country code and a mobile network code.

In an example embodiment of the apparatus at least one of the plurality of networks is a home network; and in this regard the assigning of priority value to each network includes assigning a first priority to the home network. In an example embodiment of this apparatus, at least one of the plurality of networks is a preferred network; and in that regard the assigning of priority value to each network includes assigning a second priority to the preferred network. Also in an example embodiment of this apparatus, at least one of the plurality of networks includes an un-preferred network; and wherein the assigning of a priority value to each network includes assigning a third priority value to the un-preferred network.

In a further embodiment, a computer program product is provided that includes at least one non-transitory computer readable medium having program code portions stored thereon with the program code portions configured, upon execution, cause a plurality of network identifiers to be stored in a memory; assign a priority value to each of a plurality of networks; in an instance in which a mobile terminal is roaming, identify available networks; and select an available network based on the priority value of stored network identifiers.

The computer-executable program code portions of an example embodiment may also include program instructions for determining a signal strength of the plurality of available networks; in that regard the selecting a network is further based on the signal strength of the plurality of available networks. In an example embodiment of the computer program product, assigning a priority value to a plurality of networks includes, assigning network identifiers to at least one priority list, where the priority lists are based on mobile country code and the at least one priority list is assigned a priority value. The program code portions are further configured, upon execution, to determine a dominate mobile country code; and the selecting of a network further includes selecting the network from the at least one priority list having the dominate mobile country code. In another embodiment of the computer program product, the network identifiers include a mobile country code and a mobile network code.

In an example embodiment of the computer program product, at least one of the plurality of networks is a home network; and the assigning of a priority value to each network includes assigning a first priority to the home network. In an example embodiment of this computer program code, at least one of the plurality of networks is a preferred network; and in that regard the assigning of priority value to each network includes assigning a second priority to the preferred network. Further, at least one of the plurality of networks includes an un-preferred network; and in that regard the assigning of a priority value to each network includes assigning a third priority value to the un-preferred network.

In yet another example embodiment, an apparatus is provided that includes means for storing a plurality of network identifiers in a mobile device memory; means for assigning a priority value to each of a plurality of networks; means for identifying available networks; and means for selecting an available network based on the priority value of stored network identifiers.

### BRIEF DESCRIPTION OF THE SEVERAL VIEWS OF THE DRAWINGS

Having thus described example embodiments of the invention in general terms, reference will now be made to the accompanying drawings, which are not necessarily drawn to scale, and wherein:

FIG. 1 is a schematic representation of a user device in communication with a plurality of networks in accordance with an example embodiment of the present invention;

FIG. 2 is a data flow diagram for mobile device in communication with a plurality of networks in accordance with an example embodiment of the present invention;

FIG. 3 is a block diagram of an apparatus that may be specifically configured for adaptive band selection in heterogeneous networks in accordance with an example embodiment of the present invention; and

FIG. 4 is a flow chart illustrating the operations performed, such as by the apparatus of FIG. 3, in accordance with an example embodiment of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

A method, apparatus and computer program product are provided in accordance with an example embodiment for the automatic detection and selection of an alternative network provider by a mobile device 10. The automatic detection and selection of an alternative network provider may be without manual intervention. The network providers may include, without limitation, a home network 12 (e.g. private land mobile network), an alternative or preferred network 14, or a non-preferred network 16, unknown networks, or the like. A network may be defined as a private land mobile network or other communication network architecture. A mobile device 10 may store network identifiers in a memory for each network that is a candidate to support communications with the mobile device. Network identifiers may include, without limitation, mobile country codes (MCC) and mobile network codes (MNC). The stored network identifiers may be assigned a priority value based on each network's status as a home network 12, a preferred network 14, or non-preferred network 16. The priority values may be determined by a user manually selecting priority values for each network, entered as a data file associated with a service plan, or the like. In some embodiments the priority values may be assigned to network lists or priority lists. The networks assigned to each priority list may or may not have priority values within the priority list. Networks may be assigned to a priority list based on a network identifier such as MCC.

A first priority value may be assigned to home networks 12, for example a priority of 1. A second priority value may be assigned to preferred networks 14, for example a priority of 2. A third priority value may be assigned to non-preferred networks 16, for example a priority value of 3. In this example, a priority of 1 is greater than (takes precedence over) priorities 2 and 3 and a priority of 2 is greater than (takes precedence over) priority 3, and so on.

In an alternative example embodiment, home networks 12, and preferred networks 14 may both be assigned a first priority value, for example a priority of 1. A second priority value may be assigned to non-preferred networks, for example a priority of 2. In embodiments which include priority lists each list may be given a priority value or a place holder priority value may be used. For example a preferred network list may have a priority value of 2, or priority value of two may be assigned to the APR list which is associated with a dominate MCC.

The mobile device 10 may determine the available networks. The mobile device 10 may monitor and/or sample the available networks. The mobile device 10 may associate the MCC, MNC, assigned priority value, or the like and the stored network identifiers to a corresponding available network. The mobile device may also determine the dominate MCC based on the number and/or associated signal strength of available networks with each MCC detected.

The mobile device 10 may assign a signal strength value to each available network based on sampled network signal strength. For example, full strength may be assigned a signal strength value of 5, where low signal strength may be assigned a signal strength value of 1.

The mobile device may select a network based on the priority value of the network. In an example embodiment, the mobile device may select a network, not only based on the priority value, but also the signal strength of the network. The mobile device 10 may first determine the networks available having the different network priorities, e.g. first; priority value 1: home networks, second; priority value 2: preferred networks 14, third; priority value 3: non-preferred networks 16, and forth, no assigned priority value: unknown networks 18. The mobile device 10 may select the highest priority group with an available network and, in some embodiments, may further consider the signal strength in order to select an available network.

For example, in an instance in which the highest priority group with an available network includes two or more available networks, the mobile device 10 may select the network with the highest signal strength within the highest priority group. For example, the mobile device may select a network with a signal strength value of 4 over a network with a signal strength of 3 in the selected highest priority group in an instance in which increasing signal strength values represent greater signal strength. In an instance in which more than one network of the priority group has the same signal strength value the mobile device 10 may select a network randomly, alphabetically, numerically, on a rotating basis, or the like. In an instance in which there are priority lists the mobile device may select the priority list with the highest priority value and then select a network from the priority list based on the networks priority value within the priority list and/or signal strength as discussed. In an instance in which there are priority lists associated with a dominate MCC, the mobile device may select the priority list associated with the determined dominate MCC.

The mobile device 10 may establish a connection to the selected network. The mobile device may monitor and/or sample the available networks and perform a signal strength determination at a predetermined interval. In an instance in which the mobile device 10 determines a network should be selected other than the currently selected network, the mobile device may break or discontinue the current network connection, and establish a connection with the newly selected network. For example, in an instance in which a non-preferred network 16 with a signal strength of 5 is selected and a preferred network 14 is available with a signal strength of 3, the mobile device may break the connection with the non-preferred network and establish a connection with the preferred network.

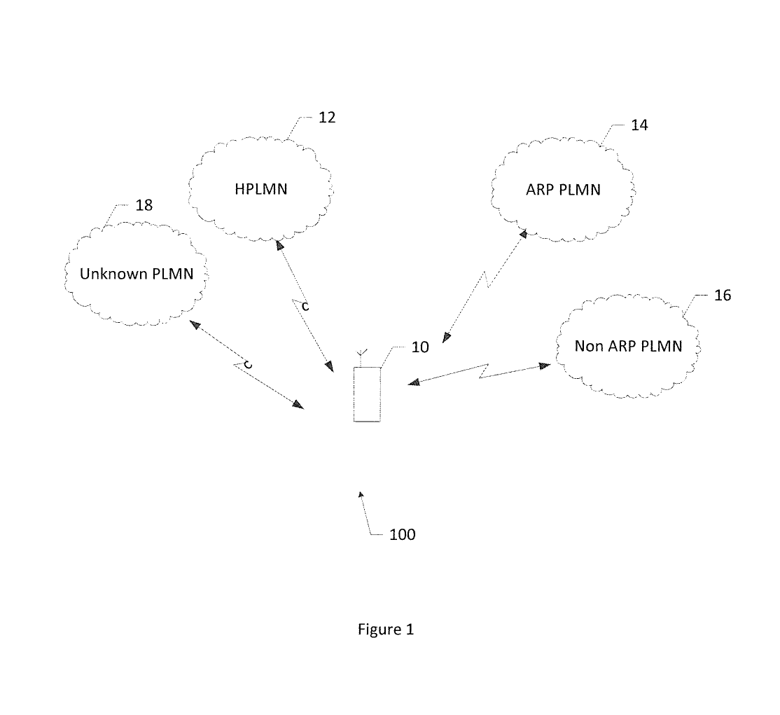

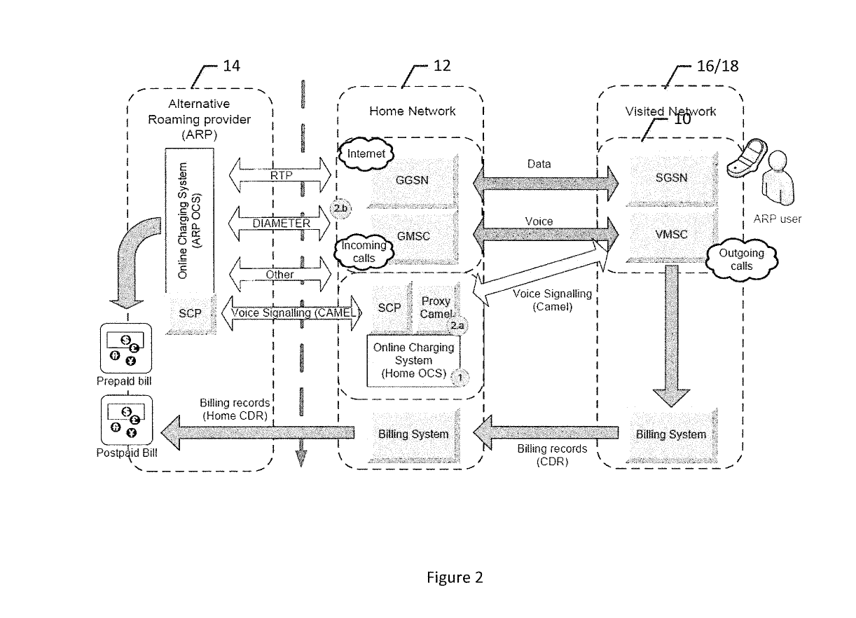

FIG. 2 illustrates a data flow diagram for mobile device (e.g. mobile device 10 as shown in FIG. 1) in communication with a plurality of networks in accordance with an example embodiment of the present invention. The mobile device may be in connection with the home network 12, an alternative roaming provider (ARP) or preferred network 14, or a visited network or a non-preferred network 16/unknown network 18.

In an instance in which the mobile device 10 is connected to the home network 12 the data and voice usage may be billed directly to the on the online charging system (OCS) of the home network. In an instance where the mobile device is connected to a preferred network 14 the data and voice usage may be calculated by the APR OCS. The APR OCS may first debit prepaid usage. In an instance in which the prepaid usage has been exhausted, the APR OCS may communicate the usage to the home OCS. The APR OCS of the non-preferred network 14 may be in connection with the network elements of the home network 12 for voice and data, such as through a real time protocol. The voice and data usage communicated from the ARP OCS to the home OCS may be directly billed to the user.

In an instance in which the mobile device 10 is connected with a non-preferred network 16 or unknown network 18, the voice and data usage may be billed separately. The home network may redirect the camel signaling to a signaling control point (SCP) through a proxy camel, which may communicate the voice usage to the home OCS and directly bill the user. The data usage may be entered in to a call data record which is sent to the home network provider and entered in to the home network provider's billing system. The home network provider may send a usage bill to the user.

A wide variety of mobile devices may be supported by the mobile networks. For example, a mobile device may be embodied as a portable digital assistant (PDA), mobile telephone, smart phone, pager, mobile television, gaming device, laptop computer, camera, tablet computer, touch surface, video recorder, audio video player, radio, electronic book, positioning device (for example, global positioning system (GPS) device, or any combination of the aforementioned, and other types of voice and data communication systems.

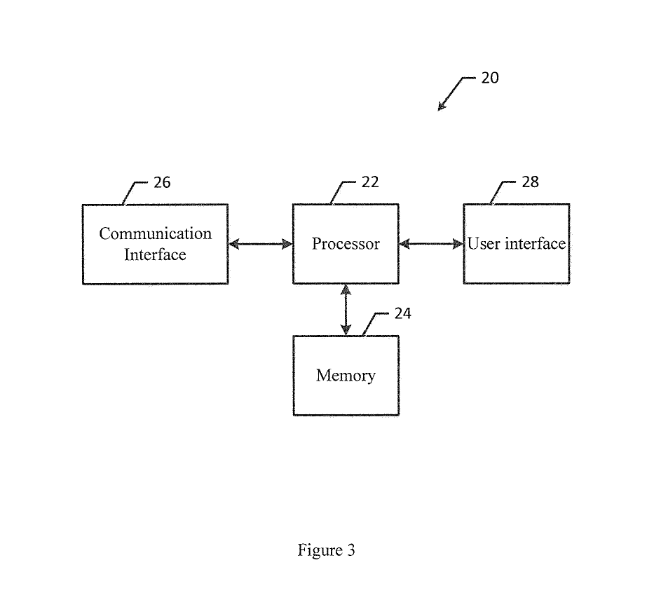

Regardless of the manner in which a mobile device 10 is instantiated, a mobile device may include or otherwise be associated with an apparatus 20 that may be configured to facilitate automatic detection and selection of an alternative roaming provider. In an example embodiment, the apparatus may be embodied as shown in FIG. 3 so as include or otherwise be in communication with a processor 22, a memory device 24, a communication interface 26 and an optional user interface 28. In some embodiments, the processor (and/or co-processors or any other processing circuitry assisting or otherwise associated with the processor) may be in communication with the memory device via a bus for passing information among components of the apparatus. The memory device 24 may be non-transitory and may include, for example, one or more volatile and/or non-volatile memories. In other words, for example, the memory device 24 may be an electronic storage device (e.g., a computer readable storage medium) comprising gates configured to store data (e.g., bits) that may be retrievable by a machine (e.g., a computing device like the processor). The memory device 24 may be configured to store information, data, content, applications, instructions, or the like for enabling the apparatus to carry out various functions in accordance with an example embodiment of the present invention. For example, the memory device 24 could be configured to buffer input data for processing by the processor 22. Additionally or alternatively, the memory device 24 could be configured to store instructions for execution by the processor 22.

As noted above, the apparatus 20 may be embodied by a mobile device 10. However, in some embodiments, the apparatus 20 may be embodied as a chip or chip set. In other words, the apparatus 20 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 20 may therefore, in some cases, be configured to implement an embodiment of the present invention on a single chip or as a single “system on a chip.” As such, in some cases, a chip or chipset may constitute means for performing one or more operations for providing the functionalities described herein.

The processor 22 may be embodied in a number of different ways. For example, the processor 22 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 22 may include one or more processing cores configured to perform independently. A multi-core processor may enable multiprocessing within a single physical package. Additionally or alternatively, the processor 22 may include one or more processors configured in tandem via the bus to enable independent execution of instructions, pipelining and/or multithreading.

In an example embodiment, the processor 22 may be configured to execute instructions stored in the memory device 24 or otherwise accessible to the processor. Alternatively or additionally, the processor 22 may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor 22 is embodied as an ASIC, FPGA or the like, the processor may be specifically configured hardware for conducting the operations described herein. Alternatively, as another example, when the processor 22 is embodied as an executor of software instructions, the instructions may specifically configure the processor to perform the algorithms and/or operations described herein when the instructions are executed. However, in some cases, the processor 22 may be a processor of a specific device (e.g., a mobile terminal or a fixed computing device) configured to employ an embodiment of the present invention by further configuration of the processor by instructions for performing the algorithms and/or operations described herein. The processor 22 may include, among other things, a clock, an arithmetic logic unit (ALU) and logic gates configured to support operation of the processor.

The apparatus 20 of an example embodiment may also include a communication interface 26 that may be any means such as a device or circuitry embodied in either hardware or a combination of hardware and software that is configured to receive and/or transmit data from/to a communications device in communication with the apparatus, such as to facilitate communications with one or more mobile device 10 or the like. In this regard, the communication interface 26 may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware and/or software for supporting communication via cable, digital subscriber line (DSL), universal serial bus (USB) or other mechanisms.

The apparatus 20 may also optionally include a user interface 28 that may, in turn, be in communication with the processor 22 to provide output to the user and, in some embodiments, to receive an indication of a user input. As such, the user interface 28 may include a display and, in some embodiments, may also include a keyboard, a mouse, a joystick, a touch screen, touch areas, soft keys, one or more microphones, a plurality of speakers, or other input/output mechanisms. In one embodiment, the processor 22 may comprise user interface 28 circuitry configured to control at least some functions of one or more user interface elements such as a display and, in some embodiments, a plurality of speakers, a ringer, one or more microphones and/or the like. The processor 22 and/or user interface circuitry comprising the processor may be configured to control one or more functions of one or more user interface 28 elements through computer program instructions (e.g., software and/or firmware) stored on a memory accessible to the processor (e.g., memory device 24, and/or the like).

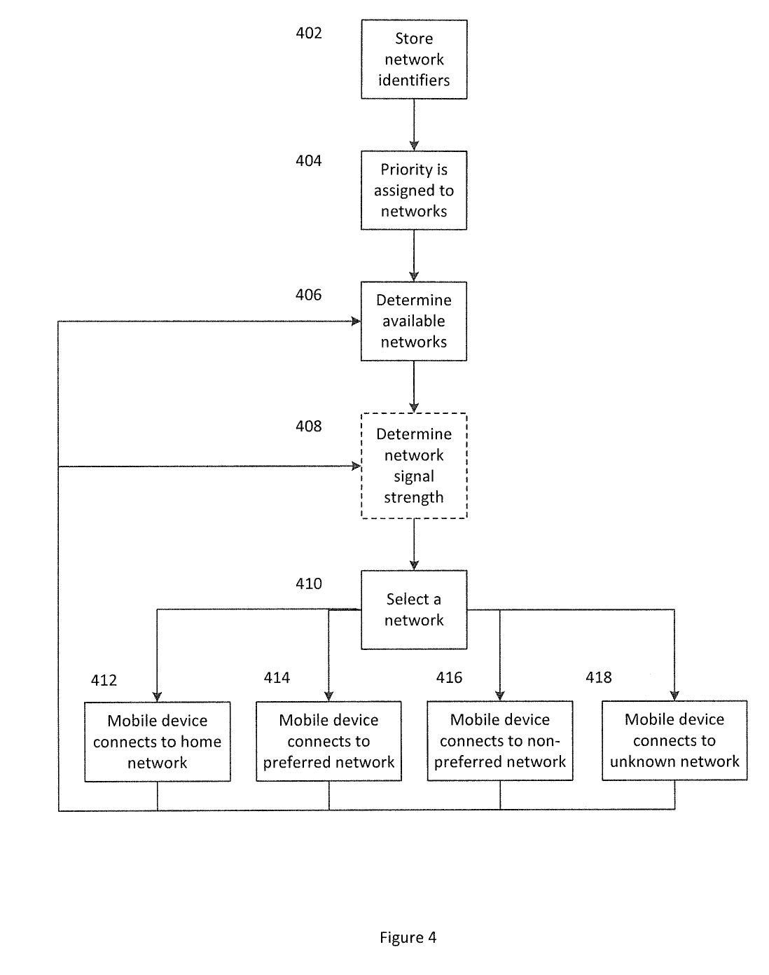

Referring now to FIG. 4, the operations performed, such as by the apparatus 20 of FIG. 3, in order to automatically detect and select an alternative roaming provider are illustrated. As shown in block 402 of FIG. 4, the apparatus may include means, such as the processor 22 or the like, for causing a plurality of network identifiers to be stored. The processor may receive the network identifiers from a user interface 28 or a communication interface 26. Additionally or alternatively, a user may enter network identifiers using the user interface 28. Still further, network identifiers may be received as a data file by the communications interface 26. The processor may cause the network identifiers to be stored. In an example embodiment, the network identifiers are stored in memory 24. The network identifiers may be stored in a removable memory, such as a SIM card. Alternatively, the network identifiers may be stored off board, such as in cloud storage, and may be accessible by the apparatus, such as the processor via the communications interface 26.

As shown in block 404 of FIG. 4, the apparatus 20 may include means, such as a processor 22 or the like, for assigning priority values to each of the stored network identifiers. The priority identifiers may be manually entered using the user interface 28 for each network identifier. The priority identifiers may alternatively be received as a data file by the communication interface or may be automatically defined in accordance with predefined rules as to the priority to be assigned to different types of networks. In an instance in which the priority values are received as data, the data may be a portion of the network identifier data or a separate priority value data. In an instance in which the priority value data is separate from the network identifier data or entered through the user interface 28, the processor 22 may associate the network identifier data and the priority data and may cause the prioritized network identifier data to be stored, such as in the memory 24.

The priority assigned to the stored network identifiers may be value based on each network's status as a home network (e.g. home network 12 as shown in FIG. 1), a preferred PLNM (e.g. preferred network 14 as shown in FIG. 1), or non-preferred network (e.g. non-preferred network 16 as shown in FIG. 1). The processor 22 may assign a first priority value to home networks 12, for example a priority of 1. The processor may assign a second priority value to preferred networks 14, for example a priority of 2. The processor may assign a third priority value to non-preferred networks 16, for example a priority value of 3.

In an alternative example embodiment, the processor 22 may assign a home network or networks 12 and preferred networks 14 a first priority value, for example a priority of 1. The processor may assign a second priority value to non-preferred networks, for example a priority of 2.

In an alternative embodiment, the home network may be assigned a priority value for some data and a differing priority data for other data. For example the processor 22 may assign a priority value of 1 to home networks 12 for voice data, and a priority value of 2 for short message service (SMS) or data. The processor may assign a priority value of 1 to the preferred network 14 for SMS and data and a priority value of 2 for voice data.

In another embodiment, the home network 12 may be assigned a priority of one, preferred networks may be divided into two lists a preferred PLMN list and an ARP list. The determination of priority lists may be based on network identifiers, such as, MCC or MNCs, in which each MCC has an associated ARP list. The preferred PLMN list may have a priority value of 2 and a priority value within the list. For example in a preferred PLMN list which includes PLMN-1, PLMN-2, and PLMN-3; PLMN-2 may have a list priority if 1, PLMN-1 may have a list priority of 2, and PLMN-3 may have a list priority of 3. The ARP list may not have list priorities, as such, each PLMN in the ARP list may have the same priority value.

In another embodiment a priority value may set for an ARP list based on the dominate MCC. For example, an ARP list may be created for multiple MCCs, such as, Germany, UK, France, or the like.

As shown in block 406 of FIG. 4, the apparatus 20 may include means, such as a processor 22 or the like, for determining available networks, such as in an instance in which the mobile device commences roaming. The processor 22 may request the communications interface 26 to monitor and/or sample the available networks at a predetermined interval or in response to a predefined trigger, such as in response to the power level or quality level of the network currently serving the mobile device falling below a predefined value. Each of the available networks may be identified by its network identifier, such as the MCC and MNC. The processor 22 may request the priority value associated with the network identifier of each of the available networks, such as form memory 24. The processor 22 may associate the MCC, MNC, assigned priority value, or the like to a corresponding available network(s).

In an additional embodiment the processor 22 may determine a dominate MCC from the available networks identified. The processor may base the determination of a dominate MCC on the number of available networks detected with each MCC and or the signal strength of each identified available network.

As shown at block 408 of FIG. 4, the apparatus 20 may include means, such as the processor 22 or the like, for determining signal strength for each available network. The processor 22 may request signal strength data from the communication interface 26. The processor may assign a signal strength value to each available network based on the signal strength data. For example, full strength may be assigned a signal strength value of 5, where low signal strength may be assigned a signal strength value of 1.

As shown in block 410 of FIG. 4, the apparatus 20 may include means, such as the processor 22 or the like, for selecting a network from the available networks. The processor may automatically select a network based on the priority value and, in some embodiments, also based on signal strength. The processor may first determine the networks available that have the highest network priority, e.g. 1) first; priority value 1: home networks 12, second; priority value 2: preferred networks 14, third; priority value 3: non-preferred networks, and fourth; no assigned priority value: unknown networks 18. The processor 22 may select the available networks having the highest priority value and, in an instance in which multiple networks have the highest priority value may provide for further signal strength selection.

In an instance in which multiple networks are available that have the highest priority value, the processor may be configured to select the highest signal strength network within the highest priority group. For example, the mobile device may select a network with a signal strength value of 4 over a network with a signal strength of 3 in the selected highest priority group. In an instance in which more than one network of the priority group has the same signal strength value the processor 22 may select a network within the group randomly, alphabetically, numerically, on a rotating basis, or the like.

In additional embodiments the apparatus may include means, such as a processor 22 or the like, for selecting an available network based on priority values and list priority. In an instance in which the stored network identifiers are further divided into priority lists, the processor 22 may select the priority list with the highest priority value. In an instance in which the priority list has list priority values the processor 22 may select the network with the highest priority value and signal strength as discussed above. In an instance in which the priority list does not have list priority values the processor 22 may select a network from the priority list with the highest signal strength.

In an instance in which the ARP list priority is based on a dominate MCC of the available networks, the processor 22 may select the ARP list with the dominate MCC. The processor may select a network from the ARP with the highest signal strength.

The apparatus 20 may include means, such as the processor 22 or the like, for causing the communication interface 26 to be communicably connected to the selected network, such as the home network 12, preferred network 14, non-preferred network 16, or unknown network 18. The mobile device may be communicably connected with the selected network in various manners, but operations 412, 414, 416, and 418 below are example embodiments of causing the communications interface 26 to be communicably connected.

As shown in block 412 of FIG. 4, in an instance in which the home network has been selected, the apparatus 20 may include means, such as the processor 22 or the like, for causing the communication interface 26 to be communicably connected a home network 12. Conversely, as shown in block 414 of FIG. 4, in an instance in which a preferred network has been selected, the apparatus 20 may include means, such as the processor 22, or the like for causing the communications interface 26 to be communicably connected to the preferred network 14. Further, as shown in block 416 of FIG. 4, in an instance in which a non-preferred network has been selected, the apparatus 20 may include means, such as the processor 22, or the like for causing the communications interface 26 to be communicably connected to a non-preferred network 16. Still further and as shown in block 418 of FIG. 4, the apparatus 20 may include means, such as the processor 22, or the like for causing the communications interface 26 to be communicably connected to an unknown network 18.

The process may continue at block 406, with the communication interface 26 connected to a selected network, the processor 22 may be configured to request the communications interface to monitor and/or sample to determine the available networks and associated signal strength data. In an instance in which the processor determines that a network should be selected other than the currently connected network, the processor requests the communication interface to break the current network connection and establish a connection with the newly selected network. The processor may be configured to determine that a different network should be selected in various manners, such as by identifying another network of a greater priority or by identifying a network of an equal priority but with a greater signal strength. For example, in an instance in which a non-preferred network 16 with a signal strength of 5 was previously selected and a preferred network 14 is available with a signal strength of 3, the mobile device may break the connection with the non-preferred network and establish a connection with the preferred network.

In an example embodiment, the processor 20 may be configured to cause the prioritized network identifiers to be stored, such as in memory. The processor 22 may be configured to determine the available networks and automatically select the network with the highest priority, such as the home network. If the home network(s) are unavailable, the processor 22 may be configured to select the next best priority group, such as the preferred networks. In an instance in which multiple available networks are in the highest priority group, the processor may be configured to select the highest signal strength network from the selected priority group and cause a connection to be established with the communications interface 26. The processor of an example embodiment may be configured to repeatedly, e.g., periodically, determine what networks are available and verify that the current network has the highest signal strength in the highest priority group. If the current network is no longer in the highest priority group of available networks or no longer has the highest signal strength within the highest priority group, the processor may be configured to cause the communications interface to break the connection with the current network and establish a connection with the network currently having the highest signal strength within the highest priority group of available networks. As the foregoing example demonstrates, automatic detection and selection of an alternative roaming provider by the method, apparatus and computer program product of an example embodiment allows the apparatus to automatically configure APNs to access an APR. Further, the user does not have to enter priority data or manually select an APR.

In an example embodiment the priority values assigned to the network identifiers may be assigned or determined based on a user or operator definition, such as based on the terms of a contract, that is the contract may specify a relative priority or the user may assign one based on cost or other contractual parameters.

In an example embodiment in which the network identifiers include MCC and MNCs, the processor 22 may be configured to select an home network 12 and/or a preferred network 14 or APR based on the country or region in which the mobile device is roaming. In this regard, the processor 22 of the mobile device may be configured to determine an instance in which the network identifier included a MCC that is associated with the country or region, different than the country or region served by the network currently being servicing the mobile device. The processor 22 may identify the available network MNCs which are associated with the MCC of the new country or region. The processor may be further configured to select an available network which is associated with the MCC of the new country or region.

In an alternative example embodiment, the processor 22 may select an available home network 12 which is associated with the MCC of the new country or region for voice data, and a preferred network 14 which may not be associated with the MCC of the new country or region for SMS or data.

As described above, FIG. 4 illustrates a flowchart of an apparatus 20, method, and computer program product according to example embodiments of the invention. It will be understood that each block of the flowchart, and combinations of blocks in the flowchart, may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 24 of an apparatus employing an embodiment of the present invention and executed by a processor 22 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included, such as illustrated by the dashed outline of block 408 in FIG. 4. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
causing a plurality of network identifiers to be stored in a memory;
assigning a priority value to each of a plurality of networks;
in an instance in which a mobile terminal is roaming, identifying available networks; and
automatically selecting an available network based on the priority value of stored network identifiers.

2. A method according to claim 1 further comprising:
determining a signal strength of the plurality of available networks; and
wherein the selecting a network is further based on the signal strength of the plurality of available networks.

3. A method according to claim 2:
wherein assigning a priority value to each of a plurality of networks further comprises, assigning network identifiers to at least one priority list, wherein the priority lists are based on mobile country code; wherein the at least one priority list is assigned a priority value,
determining a dominate mobile country code;
wherein the selecting of a network further comprises selecting the network from the at least one priority list having the dominate mobile country code.

4. A method according to claim 2:
wherein at least one of the plurality of networks is a home network;
wherein the assigning of priority value to each network includes assigning a first priority to the home network.

5. A method according to claim 4:
wherein at least one of the plurality of networks is a preferred network; and
wherein the assigning of priority value to each network includes assigning a second priority to the preferred network.

6. The method of claim 5:
wherein the at least one of the plurality of networks includes an un-preferred network; and
wherein the assigning of a priority value to each network includes assigning a third priority value to the un-preferred network.

7. A method according to claim 1:
wherein network identifiers include a mobile country code and a mobile network code.

8. An apparatus comprising at least one processor and at least one memory including computer program code, the at least one memory and computer program code configured to, with the processor, cause the apparatus to:
cause a plurality of network identifiers to be stored in a memory;
assign a priority value to each of a plurality of networks;
in an instance in which a mobile terminal is roaming, identify available networks; and
select an available network based on the priority value of stored network identifiers.

9. An apparatus according to claim 8 wherein the at least one memory and computer program code are further configured to, with the processor, cause the apparatus to:
determine a signal strength of the plurality of available networks; and
wherein the selecting a network is further based on the signal strength of the plurality of available networks.

10. An apparatus according to claim 8:
wherein assigning a priority value to a plurality of networks further comprises, assigning network identifiers to at least one priority list, wherein the priority lists are based on mobile country code; wherein the at least one priority list is assigned a priority value,
wherein the at least one memory and computer program code are further configured to, with the processor, cause the apparatus to determine a dominate mobile country code;
wherein the selecting of a network further comprises selecting the network from the at least one priority list having the dominate mobile country code.

11. An apparatus according to claim 8:
wherein at least one of the plurality of networks is a home network; and
wherein the assigning of priority value to each network includes assigning a first priority to the home network.

12. An apparatus according to claim 11:
wherein at least one of the plurality of networks is a preferred network; and
wherein the assigning of priority value to each network includes assigning a second priority to the preferred network.

13. An apparatus according to claim 12:
wherein the at least one of the plurality of networks includes an un-preferred network; and
wherein the assigning of a priority value to each network includes assigning a third priority value to the un-preferred network.

14. An apparatus according to claim 8:
wherein network identifiers include a mobile country code and a mobile network code.

15. A computer program product comprising a non-transitory computer readable medium having program code portions stored thereon, the program code portions configured, upon execution to:
cause a plurality of network identifiers to be stored in a memory;
assign a priority value to each of a plurality of networks;
in an instance in which a mobile terminal is roaming, identify available networks; and
select an available network based on the priority value of stored network identifiers.

16. A computer program product according to claim 15 wherein the program code portions are further configured, upon execution, to:
determine a signal strength of the plurality of available networks; and
wherein the selecting a network is further based on the signal strength of the plurality of available networks.

17. A computer program product according to claim 15:
wherein assigning a priority value to a plurality of networks further comprises, assigning network identifiers to at least one priority list, wherein the priority lists are based on mobile country code; wherein the at least one priority list is assigned a priority value,
wherein the program code portions are further configured, upon execution, to determine a dominate mobile country code; and
wherein the selecting of a network further comprises selecting the network from the at least one priority list having the dominate mobile country code.

18. A computer program product according to claim 15
wherein at least one of the plurality of networks is a home network;
wherein the assigning of priority value to each network includes assigning a first priority to the home network.

19. A computer program product according to claim 18:
wherein at least one of the plurality of networks is a preferred network; and
wherein the assigning of priority value to each network includes assigning a second priority to the preferred network
wherein the at least one of the plurality of networks includes an un-preferred network; and
wherein the assigning of a priority value to each network includes assigning a third priority value to the un-preferred network.

20. A computer program product according to claim 15:
wherein network identifiers include a mobile country code and a mobile network code.
